(19) United States
(12) Patent Application Publication
(10) Pub. No.: US 2016/0209316 A1
(43) Pub. Date: Jul. 21, 2016

(54) Method for determining the fouling ratio of at least one filter of a ventilation system and associated ventilation system

(71) Applicant: ALDES AERAULIQUE, Venissieux (FR)

(72) Inventors: Serge BUSEYNE, Toulouse (FR); Damien LABAUME, Preserville (FR)

(21) Appl. No.: 15/003,574

(22) Filed: Jan. 21, 2016

(30) Foreign Application Priority Data
Jan. 21, 2015 (FR) 15/50460

(51) Int. Cl. G01N 15/08; B01D 46/00

(52) U.S. Cl. CPC G01N 15/0826; B01D 46/0086; G01N 2015/084

(57) ABSTRACT

The invention concerns a method for determining the fouling ratio of at least one filter of a ventilation and/or air handling system(s) comprising the following steps:
A. Selecting at least one filter to be analyzed
B. Determining the theoretical filtration capacity of the filter selected in step A, depending on the theoretical efficiency of the filter and the maximum amount of dust which can be theoretically retained by the filter.
C. Collecting pollution data of at least one air entering the ventilation system and passing through the selected filter,
D. Measuring the air flow rate entering the ventilation system,
E. Calculating the amount of dust retained by the at least one filter selected, from the pollution data of the entering air of step C and from the measurement of the entering air flow rate of step D,
F. Repeating step E for each time step t.
G. Determining the accumulated dust amount retained by the selected filter from the results of steps E and F.
H. Determining the fouling ratio of the selected filter by comparing the accumulated dust amount determined at step G with the theoretical capacity of the filter determined in step B.

### TECHNICAL FIELD

The present invention concerns the field of ventilation systems for buildings and more particularly the ventilation systems equipped with air filters.

### BACKGROUND

Conventionally, buildings are ventilated for the issues of conservation of the assembly and discharge of pollutions, pollutions being in particular generated by the occupants, the equipment and the machinery present in the building and the materials of the assembly.

The principle of the ventilation consists in creating an exchange of the air by displacement in an enclosed place. In this case, the ventilation of a building consists in exchanging the indoor air by bringing outdoor air and/or by recycling the indoor air.

In the present application, the outdoor air means the air coming from outside the building. Furthermore, the indoor air means the ambient air present in the building.

The exchange air called entering air is generally filtered to ensure a good quality of the air in the building. Most ventilation and/or air handling systems have filters either at an air handling unit for the networks of outdoor and/or indoor air or at each air inlet or also at each air outlet.

There are several known ways for detecting the fouling of a filter. The first solution consists in adding a pressure switch in the ventilation system so that it measures the pressure on either side of the filter. When the pressure increases and reaches a predetermined threshold, the filter is considered fouled. The advantage of this solution lies in the fact that the fouling information may be immediately transmitted, however this solution does not allow anticipating the maintenance operations.

Another solution consists in using a ratioy preset timer. This timer displays an error message when the theoretical fouling delay has expired. This solution is the least expensive because it sets up an identical system for all filters and does not require an individual logistic. However, this solution does not enable knowing the fouling state of the filter in a genuine way. Indeed, the fouling depends in particular on pollutions whose rate varies over time, while the solution provided is based on a theoretical shelf life calculated on an invariable theoretical pollution. Thus, the error message may occur even though the filter is not fouled or after that said filter has become fouled.

### BRIEF SUMMARY

The invention aims to overcome all or some of the aforementioned drawbacks.

The invention provides a method for determining the fouling ratio of at least one filter of a ventilation and/or air handling system comprising the following steps:
A. Selecting at least one filter to be analyzed
B. Determining the theoretical filtration capacity of the selected filter in step A, depending on the theoretical efficiency of the filter and the maximum amount of dust which can be theoretically retained by the filter.
C. Collecting pollution data of at least one air entering the ventilation system and passing through the selected filter,
D. Measuring the flow rate of the air entering the ventilation system,
E. Calculating the amount of dust retained by the at least one selected filter, from the pollution data of the entering air of step C and from the measurement of the entering air flow rate of step D,
F. Repeating step E for each time step t.
G. Determining the accumulated dust amount retained by the selected filter from the results of steps E and F.
H. Determining the fouling ratio of the selected filter by comparing the accumulated dust amount determined at step G with the determined theoretical capacity of the filter determined in step B.

The invention has the advantage of calculating at each time step t the amount of dust retained by the selected filter, thereby enabling to follow the progress of the fouling of said selected filter and to know when the filter must be appropriately changed. Thus, the clogging of the filters can be known and even anticipated, since at any time, it is possible to know their fouling ratio. It is also possible from the data on the fouling ratio to make a forecast depending on a past and future use.

According to another feature of the invention, said determination method comprises an additional step C1 for measuring pollution data, said step C1 being carried out before the collection step C. Preferably, the measurement of the pollution data of step C1 is carried out by at least one pollution sensor of the ventilation system.

According to another feature of the invention, in the case where the entering air is outdoor entering air, step Cl may be carried out either by a weather station or by an agency specialized in the pollution measurement or by at least one pollution sensor.

According to another feature of the invention, the determination method comprises a step I for displaying the determined fouling ratio at step H. Thus, the user can visually follow the progress of the fouling ratio or the filter(s) of the ventilation system.

According to another feature of the invention, said determination method comprises an alerting step J of the fouling ratio of the at least one filter of the ventilation system. The step J allows alerting the user of the need to change the fouled filter(s).

According to one feature of the invention, said determination method comprises a step J1 prior to the alerting step J, said step J1 is a step for comparing the fouling ratio determined at step H with a fouling ratio threshold, when the determined fouling ratio is lower than the fouling ratio threshold, step J is not implemented, when the determined fouling ratio is higher than or equal to the fouling ratio threshold then step J is implemented.

Advantageously, the fouling ratio threshold corresponds to the fouling ratio considered as maximum for the at least one filter.

According to another feature of the invention, the alerting of the fouling ratio of step J is a visual alert.

According to another feature of the invention, the determination method further comprises a preventive alerting step K. said step K allows the user to know that a filter replacement should be considered.

According to one feature of the invention, the determination method further comprises a step K1 of comparing the fouling ratio determined at step H with a prevention fouling ratio threshold, when the determined fouling ratio is lower than the prevention fouling ratio threshold, step K is not implemented, when the determined fouling ratio is higher than or equal to the prevention fouling ratio threshold then step K is implemented.

Advantageously, step K1 is carried out before step J1, the prevention fouling ratio threshold being lower than the fouling ratio threshold.

According to one feature of the invention, step K is carried out after step K1 and before step J1.

According to one feature of the invention, the determination method is continuously working in order to determine the fouling of each selected filter.

According to another feature of the invention, steps C and D are consecutively carried out, step C is carried out before or after step D.

Alternatively, steps C and D are simultaneously carried out.

According to another feature of the invention, the entering air is outdoor air.

According to another feature of the invention, the entering air is indoor air.

The invention is also about a ventilation and/or air handling system in a building configured to implement the method for determining the fouling ratio of at least one filter according to the invention, said ventilation and/or air handling system comprising:
at least one air inlet,
at least one air outlet,
an element for determining the entering air flow rate,
at least one filter positioned at the at least one air inlet, said filter being arranged to be traversed by an entering air,
a unit for controlling the fouling ratio of the at least one filter, the control unit comprising a calculator configured to determine the fouling ratio of the at least one filter from the pollution data of the entering air, of the flow rate of the entering air, and of the theoretical capacity of the filter

According to one feature of the invention, said ventilation and/or air handling system comprises at least one air pollution sensor, said pollution sensor cooperating with the control unit of the ventilation and/or air handling system.

According to one feature of the invention, the at least one air pollution sensor is positioned outside the building and is configured to measure the pollution of an outdoor entering air.

According to another feature of the invention, the at least one air pollution sensor is positioned inside the building and is configured to measure the pollution of an indoor entering air, corresponding to the air extracted from one or more room(s) of the building.

According to another feature of the invention, the control unit of the fouling ratio further comprises a display member configured to display the fouling ratio of the at least one selected filter. Thus, the user can follow the fouling ratio of each of the filters of the ventilation system.

According to one feature of the invention, the control unit of the fouling ratio comprises a comparator configured to compare the determined fouling ratio with a fouling ratio threshold or with a prevention fouling ratio threshold, said comparator cooperates with a unit for analyzing the control unit, the analysis unit being configured to deduce from information of the comparator a maintenance alert which may be, for example about the change of the selected filter mandatorily or preventively.

According to one feature of the invention, the maintenance alerts transmitted by the control unit are displayed by the display member.

According to one feature of the invention, the ventilation system comprises at least one regulating member of the air flow positioned at the at least one air inlet and/or at the at least one air outlet.

According to one feature of the invention, the at least one regulating member comprises a flow meter, thereby enabling to determine the outdoor entering air flow rate and/or the indoor entering air flow rate.

In other words and according to one feature of the invention, the entering air flow rate determination element is at least one regulating member equipped with a flow meter.

According to another feature of the invention, the at least one regulating member is controlled by a unit for controlling the ventilation system.

According to another feature of the invention, the ventilation system comprises at least one outdoor entering air and/or indoor entering air fan.

According to one feature of the invention, the entering air flow rate is obtained from an information feedback from at least one outdoor entering air and/or indoor entering air fan to the control unit of the fouling ratio.

In other words and according to one feature of the invention, the entering air flow rate determination element is at least one fan of the ventilation system.

### BRIEF DESCRIPTION OF THE DRAWINGS

The invention will be better understood, due to the following description, which refers to embodiments according to the present invention, given by way of non-limiting examples and explained with reference to the appended schematic drawings, in which:

FIG. 1 schematically illustrates a ventilation system according to the invention according to a first embodiment, associated with at least one room of a building,

FIG. 2 schematically illustrates a ventilation system according to the invention according to a second embodiment, associated with several rooms and/or housing units of a building,

FIG. 3 schematically illustrates a ventilation system according to the invention according to a third embodiment, associated with a room of a building.

### DETAILED DESCRIPTION

In the present application, the ventilation and/or air handling system 1 is hereinafter referred as ventilation system 1.

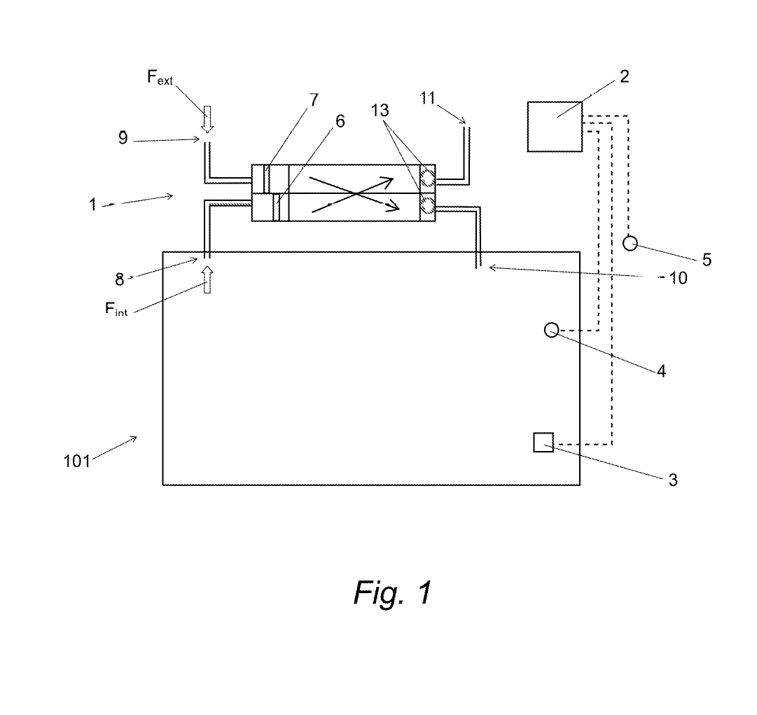

The first embodiment of the ventilation system 1 is shown in FIG. 1. In the first embodiment, the ventilation system 1 is a dual-flow system. In the example illustrated in FIG. 1, the ventilation system is associated with a room 101 of a building 100. The ventilation system 1 according to the first embodiment, comprises an outdoor air inlet 9, an indoor air inlet 8, and at least one first air outlet 10 opening into the room 101, and a second air outlet 11 opening into the outside of the building 100. A first entering air filter 7 is positioned at the outdoor air inlet 9. A second entering air filter 6 is positioned at the outdoor air inlet 8. The outdoor entering air _{Fext} and the indoor entering air Fᵢₙₜ are led to the first air outlet 10 or the second air outlet 11 by means of fans 13.

Preferably, the entering air flow rate is given by an information feedback from the fans 13. In a not-shown variant, the ventilation system may comprise one or more regulating member(s) equipped with a flow meter.

In FIG. 1, the ventilation system 1 is equipped with an outdoor pollution sensor 5 and an indoor pollution sensor 4. Of course, the ventilation system 1 may comprise according to the invention a plurality of outdoor pollution sensors 5 and/or a plurality of indoor pollution sensors 4.

As shown in FIG. 1, the ventilation system 1 further comprises a control unit of the fouling ratio 2. Said control unit of the fouling ratio 2, is configured to determine the fouling ratio of the entering air filters 7, 6, of the ventilation system 1.

The control unit of the fouling ratio 2 comprises a display member 3 configured to alert and display the fouling ratio of each filter 7, 6. In the example illustrated in FIG. 1, the control unit of the fouling ratio 2 and the display member 3 are separated. This example is not limiting and the display member 3 might be alternatively structurally integrated in the control unit of the fouling ratio 2 and according to the invention.

The determination of the fouling ratio of an entering air filter is carried out as follows. The filter to be analyzed is for example the outdoor entering air filter 7. The theoretical efficiency of the outdoor entering air filter 7 and the maximum amount of dust which may be theoretically retained by the outdoor entering air filter 7 are prerecorded in the control unit of the fouling ratio 2 or known and are standards. We determine the theoretical filtration capacity of the selected filter 7 from the theoretical efficiency of the outdoor entering air filter 7 and the maximum amount of dust which may be theoretically retained by the outdoor entering air filter 7.

The outdoor pollution sensor 5 measures the outdoor pollution at a time t in μg/m³ and the outdoor pollution data are collected by the control unit of the fouling ratio 2. The fans 13 measure the outdoor entering air flow rate in m³/h and transmit the information to the control unit of the fouling ratio 2. The control unit of the fouling ratio 2 then calculates from the gathered data (outdoor entering air pollution and outdoor entering air flow rate) the amount of dust in μg/m³ passing through the outdoor entering air filter 7. Then, the control unit of the fouling ratio 2 determines the fouling ratio of the outdoor entering air filter 7 by calculating the amount of dust retained by the filter over a time step t and summing this value to that already retained by the filter previously calculated. The accumulated dust amount is compared with the determined theoretical capacity of the filter at a previous step.

The determination of the fouling ratio of the indoor entering air filter 6 is carried out according to the same method, the difference being about the measurement of the indoor entering air flow rate and the indoor pollution data transmitted by the indoor pollution sensor 4.

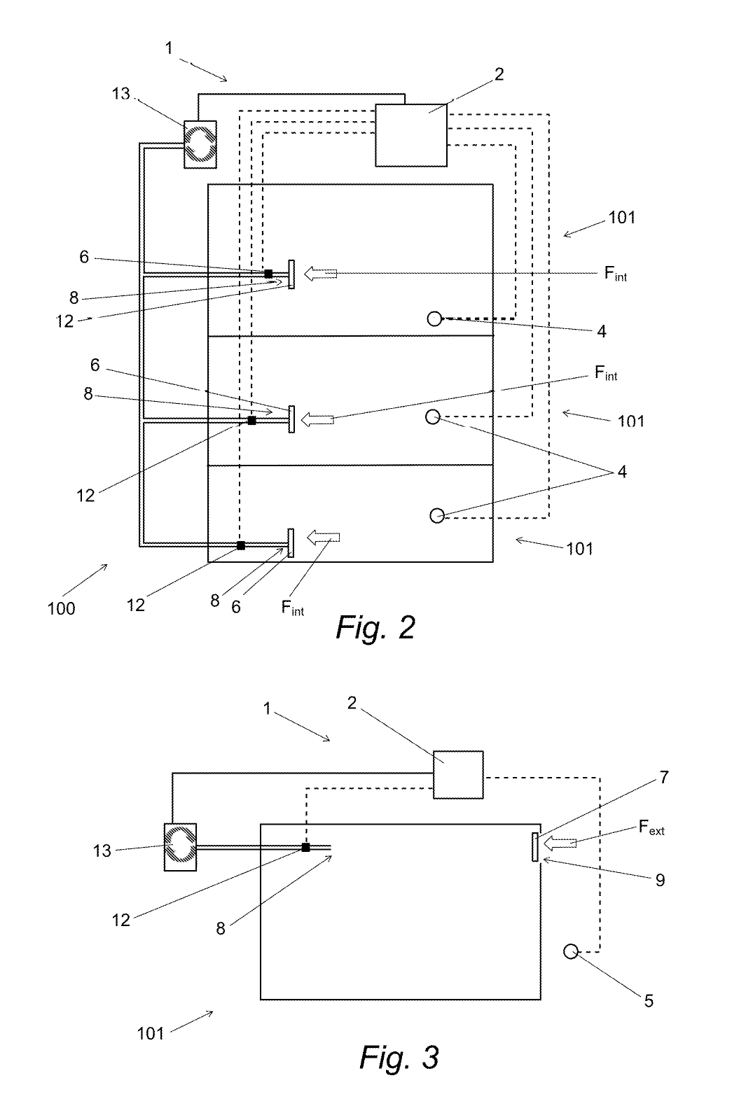

The second embodiment of the ventilation system 1 is shown in FIG. 2. In the second embodiment, the ventilation system 1 is a single flow system of several rooms 101 of a building 100. This embodiment may be also used for collective housing units of a building 100.

In the second embodiment, each room 101 comprises an extraction outlet corresponding to an indoor entering air inlet 8 at which an entering air filter 6 is positioned. The ventilation system 1 further comprises an indoor pollution sensor 4 by room 101. The ventilation system 1 also comprises a control unit of the fouling ratio 2 cooperating with each indoor pollution sensor 4 in order to determine the fouling ratio of each indoor entering air filter 6. Furthermore, the ventilation system 1 comprises a regulating member 12 for each indoor entering air inlet 8. Each regulating member 12 is equipped with a flow meter.

The determination of the fouling ratio of an indoor entering air filter 6 is carried out as described in the first embodiment. By using the indoor pollution data of the pollution sensor 4 of the room 101 in which is located the filter 6 and the air flow rate data measured by the regulating member 12 of the associated room 101.

The third embodiment of the ventilation system 1 is shown in FIG. 3. In the third embodiment, the ventilation system 1 is a single flow system for a room 101 of a building 100. This embodiment may also be used for collective housing units as well as for individual housing units.

In the third embodiment, the room 101 comprises an extraction outlet corresponding to an outdoor entering air inlet 9 at which an entering air filter 7 is positioned. The ventilation system 1 further comprises an outdoor pollution sensor 5. The ventilation system 1 also comprises a control unit of the fouling ratio 2 cooperating with the outdoor pollution sensor 5 in order to determine the fouling ratio of the outdoor entering air filter 7. Furthermore, the ventilation system 1 comprises a regulating member 12 for the extraction outlet 8. The regulating member 12 is equipped with a flow meter.

The determination of the fouling ratio of an outdoor entering air filter 7 is carried out as described in the first embodiment. By using the outdoor pollution data of the outdoor pollution sensor 5 of the room 101 in which is located the filter 7 and the air flow rate data measured by the regulating member 12 of the room 101 or by an information feedback from the fan 13.

As an alternative of the first embodiment and the third embodiment, the outdoor pollution is measured by a weather station.

As an alternative of the first embodiment and the third embodiment, the outdoor pollution is measured by an external agency and the pollution data are made available and collected via internet for example, by the control unit of the fouling ratio 2.

As an alternative of any one of the embodiments, the air flow rate measurement is performed by a measuring member other than the regulating member equipped with a flow meter, for example the fan 13.

Of course, the invention is not limited to the embodiments described and shown in the appended figures. Modifications are possible, in particular from the point of view of the constitution of the various elements or by substitution of technical equivalents, without departing from the scope of the invention.

1. A method for determining the fouling ratio of at least one filter of a ventilation and/or air handling system(s) comprising the following steps:
A. Selecting at least one filter to be analyzed
B. Determining the theoretical filtration capacity of the filter selected in step A, depending on the theoretical efficiency of the filter and the maximum amount of dust which can be theoretically retained by the filter.
C. Collecting pollution data of at least one air entering the ventilation system and passing through the selected filter,
D. Measuring the flow rate of the air entering the ventilation system,
E. Calculating the amount of dust retained by the at least one selected filter, from the pollution data of the entering air of step C and from the measurement of the entering air flow rate of step D,
F. Repeating step E for each time step t.
G. Determining the accumulated dust amount retained by the selected filter from the results of steps E and F.
H. Determining the fouling ratio of the selected filter by comparing the accumulated dust amount determined at step G with the theoretical capacity of the filter determined in step B.

2. The determination method according to claim 1, wherein said determination method comprises an additional step C1 of measuring pollution data, said step C1 being carried out before the collection step C.

3. The determination method according to claim 1, wherein the determination method comprises a step I of displaying the fouling ratio determined in step H.

4. The determination method according to claim 1, wherein said determination method comprises a step J of alerting the fouling ratio.

5. The determination method according to claim 4, wherein said determination method comprises a step J1 prior to the alerting step J, said step J1 being a step for comparing the fouling ratio determined at step H with a fouling ratio threshold, when the determined fouling ratio is lower than the fouling ratio threshold, step J is not implemented, when the determined fouling ratio is higher than or equal to the fouling ratio threshold, then step D is implemented.

6. The determination method according to claim 1, wherein steps C and D are carried out consecutively, step C being carried out before or after step D or steps C and D are simultaneously carried out.

7. The determination method according to claim 1, wherein the entering air is outdoor air.

8. The determination method according to claim 1, wherein the entering air is indoor air.

9. A ventilation and/or air handling system(s) in a building configured to implement the method for determining the fouling ratio of at least one filter according to claim 1, wherein said ventilation and/or air handling system(s) comprise(s):
at least one air inlet,
at least one air outlet,
an element of determining the entering air flow rate,
at least one filter positioned at the at least one air inlet, said filter being arranged to be traversed by an entering air,
a unit of controlling the fouling ratio of the at least one filter, the control unit comprising a calculator configured to determine the fouling ratio of the at least one filter from the pollution data of the entering air, the flow rate of the entering air, and the theoretical capacity of the filter

10. The ventilation and/or air handling system(s) according to claim 9, comprising at least one air pollution sensor, said pollution sensor cooperating with the control unit of the ventilation and/or air handling system(s).
